(19) United States
(12) Patent Application Publication
(10) Pub. No.: US 2024/0128918 A1
(43) Pub. Date: Apr. 18, 2024

(54) APPARATUS, SYSTEM, AND METHOD FOR WIND-RESILIENT SOLAR PANEL RACKING

(71) Applicant: Quest Renewables, Inc., Atlanta, GA (US)

(72) Inventors: Darby Allison, Atlanta, GA (US); Norman Painter Findley, IV, Atlanta, GA (US); James Keane, Atlanta, GA (US); Lauren Terris, Arvada, CO (US)

(21) Appl. No.: 18/335,704

(22) Filed: Jun. 15, 2023

Related U.S. Application Data
(60) Provisional application No. 63/415,789, filed on Oct. 13, 2022.

(51) Int. Cl. H02S 20/10

(52) U.S. Cl. CPC H02S 20/10

(57) ABSTRACT

Apparatuses, systems, and methods for providing wind-resilient solar panel racking structures. The solar panel racking structures having first and second upper panel mount assemblies, first and second base assemblies, and first and second sets of solar panels. The upper panel mount assemblies and base assemblies linked by cross-braces and together forming a tent-like structure for supporting the solar panels at an angle.

### CROSS REFERENCE TO RELATED APPLICATION

This application claims the benefit of U.S. Provisional Patent Application No. 63/415,789 filed on Oct. 13, 2022, which is hereby incorporated by reference in its entirety.

### STATEMENT REGARDING FEDERALLY SPONSORED RESEARCH OR DEVELOPMENT

This invention was made with Government support under Award Number DE-SC0020038 awarded by the U.S. Department of Energy Office of Science. The Government has certain rights in this invention.

### FIELD OF THE INVENTION

Disclosed are apparatuses, systems, and methodologies for wind-resilient, prefabrication-capable, solar panel racking systems.

### BACKGROUND

Structural wind loads commonly govern the material requirements of solar panel racking systems (e.g., solar canopies, flat roof racking systems, ground-mount racking systems, etc.). Flat roof solar panel racking systems are mounted directly onto a flat roof, whereas the solar panels in solar canopies are mounted generally between 2 and 15 feet off of the ground. Solar canopy technologies may, for example, be used in any open public or private spaces such as parking lots, parks, sidewalks, playgrounds, parking garages, covered markets, equipment storage facilities, etc. Ground-mount racking systems are typically mounted low to the ground—between 1 and 7 feet off of the ground.

Due to traditional steel erection methods and aerial installation methods as well as limitations in conventional racking structures, existing solar racking technologies including roof mount, ground-mount, and canopy systems, are typically assembled in situ, i.e., their component parts are shipped to the site where they will operate and then are assembled largely piece-by-piece, from the ground up, often using scaffolding. In situ assembly of solar racking systems introduces many costs via difficulties at least with logistics (timely shipping of parts to sites), assembly labor (assembly at a site may require more time and workhours), and functional site downtime. Conventional solar panel racking structures, however, are not suited to prefabrication, because their design, which is focused on withstanding in situ wind forces, does not readily withstand the types of forces introduced by crane-lifting a pre-fabricated structure into place on supports, a necessary step in any prefabrication and installation process.

Many conventional systems further incorporate wind load reduction strategies that can be inadequate for heavy winds, even following conventional, in situ installation.

Therefore, there is a long-felt and unresolved need for an apparatus, system, and method for solar panel racking that provides a racking structure that is constructed to substantially withstand loading associated with crane-lifting of a prefabricated structure into place during installation and simultaneously maintains or improves the structure's ability to withstand applied wind loads and/or effectively reduces wind loads. There is a further need for a reduction in manufacturing and installation time and cost associated with such an apparatus, system, or method, in order to meet efficiency demands for the cost of solar energy while maintaining adequate structural integrity in the face of applied wind loads. In view of the foregoing, the present invention relates to improvements upon the known apparatuses, systems, and methods with respect to reduction of applied wind loads, ability to withstand wind loads, and efficiency in manufacturing and installation of solar racking systems.

### SUMMARY

In response to the difficulties and problems encountered in the industry, a new solar panel apparatus, system, and methodology has been invented.

In accordance with aspects of certain embodiments of the present invention, the solar racking structure may include a first solar racking unit including a base assembly having at least first and second base members, and an upper panel mount assembly having an outer upper chord and an inner upper chord, a lower chord, at least first and second web strut clusters, at least first and second ground strut clusters, and at least first and second transverse struts, wherein each of the first and second transverse struts of the first solar racking unit connects the outer upper chord of the first solar racking unit to the inner upper chord of the first solar racking unit. The solar racking structure may further include a second solar racking unit including a base assembly having at least first and second base members, and an upper panel mount assembly having an outer upper chord and an inner upper chord, a lower chord, at least first and second web strut clusters, at least first and second ground strut clusters, and at least first and second transverse struts, wherein each of the first and second transverse struts of the second solar racking unit connects the outer upper chord of the second solar racking unit to the inner upper chord of the second solar racking unit. The solar racking structure may further include at least first and second cross-braces, wherein the first cross-brace attaches the first base member of the first solar racking unit to the inner upper chord of the second solar racking unit and the second cross-brace attaches the first base member of the second solar racking unit to the inner upper chord of the first solar racking unit. Each web strut cluster of each solar racking unit may attach the lower chord to the inner and outer upper chords of each, respective solar racking unit. The first ground strut cluster of each solar racking unit may attach the first base member to the inner and outer upper chords of each, respective solar racking unit, and the second ground strut cluster of each solar racking unit may attach the second base member to the inner and outer upper chords of each, respective solar racking unit.

The first solar racking unit of the solar panel racking structure of the present invention may support a first set of solar panels attached directly or indirectly to the upper panel mount assembly of the first solar racking unit and the second solar racking unit may support a second set of solar panels attached directly or indirectly to the upper panel mount assembly of the second solar racking unit. Each solar racking unit may further include third and fourth web strut clusters. Moreover, the first set of solar panels and second set of solar panels may be supported by their respective solar racking units such that each set of solar panels slopes upward toward a midpoint line between the solar racking units, and the solar panel racking structure forms a tent-like structure. One or more of the web struts, ground struts, transverse struts, and cross-braces may be rigid. Further, one or more of the web struts, ground struts, transverse struts, and cross-braces may be composed of steel. Each base member may be composed of concrete.

In accordance with certain aspects of another embodiment of the present invention, a solar panel racking structure is provided. The solar panel racking structure may include a first and second solar racking unit, each having a base assembly and an upper panel mount assembly. The solar panel racking structure may further include a first and second set of solar panels, wherein the first set of solar panels are secured to the upper panel mount assembly of the first solar racking unit and the second set of solar panels are secured to the upper panel mount assembly of the second solar racking unit. The solar panel racking structure may further include at least first and second cross-braces, wherein the first cross-brace attaches the base assembly of the first solar racking unit to the upper panel mount assembly of the second solar racking unit and the second cross-brace attaches the base assembly of the second solar racking unit to the upper panel mount assembly of the first solar racking unit. The first and second set of solar panels may each slope upward toward a midpoint line between the first solar racking unit and the second solar racking unit such that the solar panel racking structure forms a tent-like structure.

The solar panel racking structure of the present invention may be a ground-mount solar panel racking structure, and a lowest edge of the solar panels secured thereon may reside 1.5 feet to 8 feet above the ground. Further, each of the magnitude of a tilt angle, θa, formed between a plane formed by the first set of solar panels and a plane formed by the horizon and the magnitude of a tilt angle, θb, formed between a plane formed by the second set of solar panels and the plane formed by the horizon, may be between 5 and 30 degrees. The solar panel racking structure of the present invention may include a gap between an uppermost edge of the first set of solar panels and an uppermost edge of the second set of solar panels. In one embodiment, the gap may be between 8 and 40 inches wide. Moreover, the upper panel mount assemblies of each solar racking unit may be capable of withstanding the forces applied by crane lifting of the upper panel mount assemblies. Additionally, the solar panel racking structure is preferably capable of withstanding category 5 hurricane force winds. In certain embodiments, the solar panel racking structure provides a load distribution in category 5 hurricane force winds such that no portion of the solar panel racking structure experiences a GCn greater than 3.0 as measured according to ASCE 49-21 and calculated according to ASCE 7-16. The cross-braces of the solar panel racking structure may be rigid. Further, the cross-braces may be composed of steel. The base assemblies of the solar panel racking structure may be composed of concrete.

Each solar racking unit of the solar panel racking structure of the present invention may define a width dimension, W, and a length dimension, L, with each dimension bounded by the surface area of an upper face of each set of solar panels, thus defining an aspect ratio for each solar racking unit, W:L. In one embodiment, the aspect ratio of each solar racking unit may be less than 0.7. Further, W for each solar racking unit may be between about 10 feet and about 27 feet and L for each solar racking unit may be between about 44 feet and about 110 feet. Each solar racking unit may define an interior dimension, B, spanning between the centers of the base assemblies. B may be between 30 feet and 90 feet in length. Each solar racking unit may define a cantilever dimension, C, spanning from the center of each base assembly to a nearest outer end of the length dimension L. C may be between 10 feet and 30 feet in length. A gap may be formed between an uppermost edge of the first set of solar panels and an uppermost edge of the second set of solar panels along the entirety of the length dimension, L of the solar racking units. The gap may be between about 8 and about 40 inches wide. The first and second solar racking units may each further include an upper panel mount assembly having an outer upper chord, an inner upper chord, and first and second transverse struts. Further, each of the first and second transverse struts of an upper panel mount assembly may connect the outer upper chord to the inner upper chord of said upper panel mount assembly.

The present invention further includes a method for prefabrication assembly. The method may include the steps of A) providing a first and second upper panel mount assembly and a first and second base assembly; B) securing the first and second base assembly at a work site; C) lifting the first upper panel mount assembly into place on the secured first base assembly; D) lifting the second upper panel mount assembly into place on the secured second base assembly; E) providing first and second cross-braces; F) attaching a first end of the first cross-brace to the first upper panel mount assembly and a second end of the first cross-brace to the second base assembly; G) attaching a first end of the second cross-brace to the second upper panel mount assembly and a second end of the second cross-brace to the first base assembly; H) securing a first set of solar panels to the first upper panel mount assembly; and I) securing a second set of solar panels to the second upper panel mount assembly, such that the first and second sets of solar panels each slope upward toward a midpoint line between the first and second upper panel mount assemblies to form a tent-like structure.

According to the method of the present invention, each base assembly may include a first base member and a second base member. Further, the first upper panel mount assembly may include an outer upper chord and an inner upper chord, a lower chord, a first and second web strut clusters, a first and second ground strut clusters, and a first and second transverse struts, wherein each of the first and second transverse struts may connect the outer upper chord to the inner upper chord. The method of the present invention may also include the step of J) attaching the ground struts of the upper panel mount assembly to the base assembly to support the upper panel mount assembly.

In accordance with certain aspects of further embodiments of the present invention, the solar panel racking structures disclosed herein are adapted for ground-mount, roof-mount, or canopy-mount applications.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIG. 1 is a longitudinal view of a solar racking unit including dashed lines to show dimensions in accordance with examples of this disclosure.

FIG. 2 is a top, side perspective view of a solar panel racking structure including dashed lines to show dimensions in accordance with examples of this disclosure.

FIG. 3 is a top, side perspective view of solar panel racking structure in accordance with examples of this disclosure.

FIG. 4 is a latitudinal view of a solar racking unit including purlins in accordance with examples of this disclosure.

FIG. 5 is a top, side perspective view of a solar panel racking structure including purlins in accordance with examples of this disclosure.

FIG. 6 is a top, side perspective view of a solar panel racking structure including purlins in accordance with examples of this disclosure.

FIG. 7 is a longitudinal view of a solar racking unit including solar panels and an illustrative, imaginary plane in accordance with examples of this disclosure.

FIG. 8 is a top, side perspective view of a solar panel racking structure including solar panels, two illustrative, imaginary planes, and dashed lines to show dimensions, in accordance with examples of this disclosure.

FIG. 9 is a top, side perspective view of solar panel racking structure including solar panels and dashed lines to show dimensions in accordance with examples of this disclosure.

FIG. 10 is a top, side perspective view of a solar panel racking structure in accordance with examples of this disclosure.

FIG. 11 is a top-down, diagrammatic view of an exemplary solar panel racking structure.

### DETAILED DESCRIPTION

Reference will now be made in detail to various embodiments of the invention, one or more examples of which are illustrated in the drawings. Each example is provided by way of explanation of the invention, and is not meant as a limitation of the invention. For example, features illustrated or described as part of one embodiment may be used with a second embodiment to yield a third embodiment. It is intended that the present application include such modifications and variations as come within the scope and spirit of the invention. Repeat use of reference characters throughout the present specification and appended drawings is intended to represent the same or analogous features or elements of the invention.

Before any embodiments of the invention are explained in detail, it is to be understood that the invention is not limited in its application to the details of construction or to the arrangement of components set forth in the following description or illustrated in the drawings. The invention is capable of other embodiments and of being practiced or of being carried out in various ways. Also, it is to be understood that the phraseology used herein is for the purpose of description and should not be regarded as limiting. The use of formatives of the words “include,” “comprise,” and “have” is meant to encompass the items listed thereafter and equivalents thereof, as well as additional items. Unless specified or limited otherwise, the terms “connected” and “carried by” are used broadly and encompass direct and indirect mountings, connections, supports, or couplings. Further, such phraseology is not limited to physical or mechanical connections or couplings.

The recitation of a numerical range using endpoints includes all numbers subsumed within that range, including rounding (e.g., 1 to 5 includes 1, 1.5, 2, 2.75, 3, 3.80, 4, 5, etc.).

The terms “a,” “an,” “the,” “at least one,” and “one or more” are used interchangeably. Thus, for example, a solar panel racking structure that contains “a” support member means that the solar panel racking structure includes “one or more” support members.

As used herein, the term “about” when applied to a value should be interpreted in context to suggest said value further encompasses a modest amount beyond the exact value, as would be understood by a person having ordinary skill in the art in light of this disclosure.

The term “in situ” means as applied to a subject solar panel racking structure or component thereof that said solar panel racking structure or component thereof is at the site of its intended installation, either fully installed or in preparation for installation, as context may dictate.

As used herein, the term “substantially equivalent” when applied with respect to a set of values means each value within the set falls within a range having an upper bound that is 5% greater than an average of the set of values and a lower bound that is 5% lower than the average of the set of values.

The term “uplift force” refers to the force exerted by wind on the underside of a solar panel racking structure. The uplift force or an associated normal force coefficient imparted by wind on the underside of conventional solar panel racking structures is expected by those of ordinary skill in the art to decrease with an increasing tilt angle of solar panels mounted on conventional solar panel racking structures.

Aspects of the present disclosure generally relate to apparatuses, systems, and methods for providing solar panel racking structures and coupling adjacent solar racking units into a unitized solar panel racking structure to reduce wind loads on and increase the structural integrity of the solar panel racking units and combined structures. The entirety of the coupled solar panel racking structure provides improved outcomes for ease of manufacturability, assembly and installation, and structural integrity, including ability to withstand wind forces and/or forces imparted by crane lifting of pre-assembled component parts. Generally, the disclosed apparatuses, systems, and methods utilize cross-bracing struts to attach a first solar racking unit of a particular structure to the base of a second solar racking unit and vice versa. In various embodiments, a solar panel racking structure generally includes two solar racking units with at least one solar panel mounted on top of each solar racking unit.

In exemplary embodiments, each solar racking unit in a solar panel racking structure includes a base assembly and an upper panel mount assembly. The upper panel mount assembly is capable of bearing at least one solar panel.

In preferred embodiments, each solar racking structure is composed of two solar racking units and a first solar racking unit supports a first set of solar panels and a second solar racking unit supports a second set of solar panels. The two solar racking units may be coupled via cross-bracing. The first and second sets of solar panels preferably form a tent-like structure, with each of the first and second sets of solar panels sloping in an upward direction to a midline formed between the two sets of solar panels along a length of the solar racking units.

In certain embodiments, the upper panel mount assembly includes two upper chords (upon which at least one solar panel may be mounted directly or indirectly), an inner upper chord and an outer upper chord, and one lower chord, between which and to which various strut supports are attached. In various embodiments, the upper and lower chords of the upper panel mount assembly run the length of each solar racking unit. At one end of the solar racking unit, a first ground strut cluster including at least one ground strut may be used to attach the upper panel mount assembly to a first base member of the base assembly. In preferred embodiments, each ground strut attaches to the first base member and an upper chord. Similarly, at the other end of the solar racking unit, a second ground strut cluster including at least one ground strut may be used to attach the upper panel mount assembly to a second base member of the base assembly. In preferred embodiments, each ground strut of the second ground strut cluster attaches to the second base member and an upper chord. In further embodiments, additional ground strut clusters may be used to further attach the upper panel mount assembly to the base assembly at first, second, or additional base members.

In one embodiment, at one end of the solar racking unit, a first web strut cluster having at least two web struts may be used to attach the upper chords to the lower chord. A first web strut of the first web strut cluster attaches the lower chord to the first upper chord, and a second web strut of the first web strut cluster attaches the lower chord to the second upper chord. The first web strut cluster may include additional web struts that each attach the lower chord to an upper chord. In a preferred embodiment, the first web strut cluster includes four web struts, and first and third web struts of the first web strut cluster attach the lower chord to the first upper chord, and second and fourth web struts of the first web strut cluster attach the lower chord to the second upper chord. Similarly, at the other end of the solar racking unit, a second web strut cluster having at least two web struts may be used to further attach the upper chords to the lower chord. A fifth web strut of the second web strut cluster attaches the lower chord to the first upper chord, and a sixth web strut of the second web strut cluster attaches the lower chord to the second upper chord. The second web strut cluster may include additional web struts that each attach the lower chord to an upper chord. In a preferred embodiment, the second web strut cluster includes four web struts, and fifth and seventh web struts of the second web strut cluster attach the lower chord to the first upper chord, and sixth and eighth web struts of the second web strut cluster attach the lower chord to the second upper chord. In further embodiments, the solar racking units may include additional such web strut clusters.

In various embodiments, ground strut clusters and web strut clusters may attach at various positions along the length of the perimeter solar panel racking structures.

In further embodiments, the upper mounting assembly may include transverse and diagonal struts connecting and providing support for and between the upper chords of a single solar racking unit.

In some embodiments, solar panels are directly mounted onto or attached to the upper chords of each solar racking unit. In further embodiments, solar panels are directly mounted onto or attached to the diagonal or transverse struts. In still further embodiments, the upper panel mount assembly includes at least one panel rail or purlin that is attached to the upper chords, transverse struts, or diagonal struts or are otherwise mounted onto the upper panel mount assembly. In such further embodiments, solar panels may be attached or affixed or maintained in place by the panel rails or purlins.

In preferred embodiments, the various components of the upper panel mount assembly are rigid. In further preferred embodiments, the various components of the upper panel mount assembly are composed of steel or other suitable material.

In some embodiments, each solar racking unit includes a base assembly that has at least one base member. A base member may have any number of suitable shapes or structures as is appropriate or otherwise effective for the ground or surface that the base member is attached to or on which the base member rests. Base members may also have varying shapes or structures as is appropriate or effective for connection with components of the upper panel mount assembly. In some embodiments, base members are each columnar and formed of concrete. In a further embodiment, each base assembly includes two base members. In an even further embodiment, each base assembly includes three base members. In a still further embodiment, each base assembly includes four base members. In the event that the base assembly includes more than one base member, each base member may be the same or different from other base members, varying in size, shape, material, or configuration. The base assemblies of two solar racking units within the same solar panel racking structure can, but need not be the same with respect to configuration, makeup, or the like.

In various embodiments, each solar racking unit of a single solar panel racking structure may be substantially identical in construction and configuration though each solar racking unit may be positioned or anchored in a different orientation according to embodiments described herein. In this way, ease of manufacturing can be achieved, where each unit uses the same component parts that have the same orientation, reducing the number or varieties of parts needed.

As will occur to one having ordinary skill in the art unless otherwise stated, this disclosure is not limited as to the number, configurations, or types of solar panel racking structures, solar racking units, solar panels, base assemblies, base members per base assembly, upper panel mount assemblies, base struts, web trusses or web truss struts, upper or lower chords, diagonal or transverse struts, purlins/panel rails, connectors including devises or other connectors, or cross-braces that may be used in association with the present disclosure.

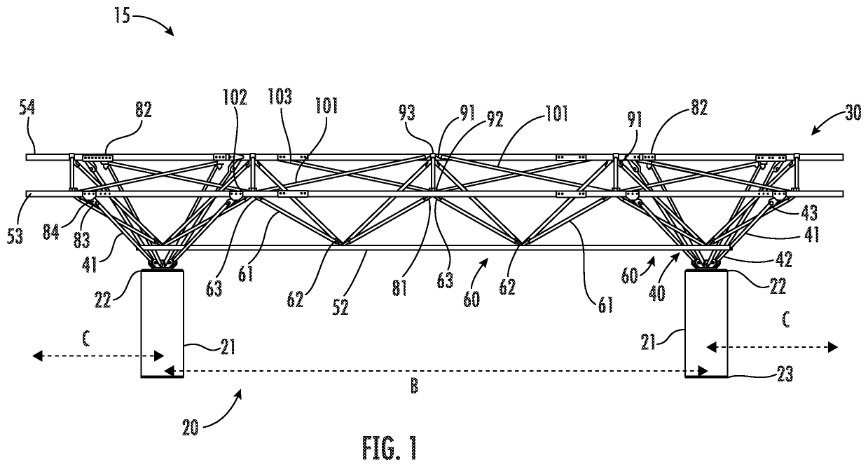

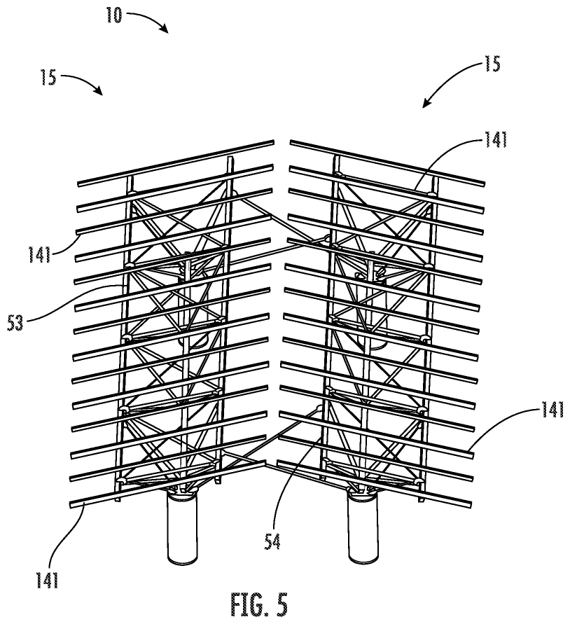

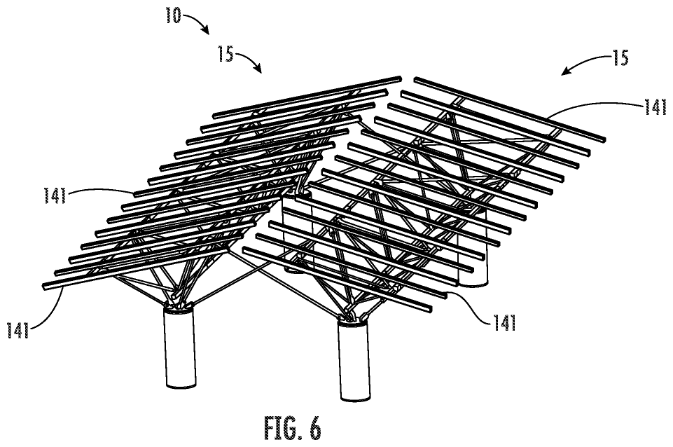

Referring now to FIGS. 1-10, exemplary embodiments of solar racking units 15 and solar panel racking structures 10 are shown. Each depicted solar racking structure 10 may include two solar racking units 15.

Referring to FIG. 1, each solar racking unit 15 includes a base assembly 20 and an upper panel mount assembly 30. In certain embodiments, each base assembly 20 includes two columnar base members 21. Said columnar base members 21 may be formed of concrete and have a base member upper end 22 and a base member lower end 23.

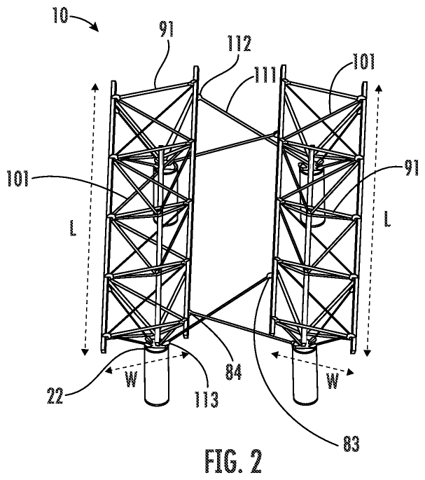

Each upper panel mount assembly 30 depicted may include a lower chord 52, an outer upper chord 53, an inner upper chord 54, two ground strut clusters 40, and four web strut clusters 60. In certain embodiments, the inner upper chord 54 may be positioned higher in elevation relative to the horizon than the outer upper chord 53. Each of the inner upper chord 54, outer upper chord 53, and lower chord 52 may be substantially parallel. Ground strut clusters 40 may include at least one ground strut 41 connected at a ground strut lower end 42 to a base member upper end 22 and at a ground strut upper end 43 to an outer upper chord 53 or an inner upper chord 54. Web strut clusters 60 may include at least one web strut 61 connected at a web strut lower end 62 to a lower chord 52 and at a web strut upper end 63 to an outer upper chord 53 or an inner upper chord 54. In various embodiments, each upper panel mount assembly 30 may further include at least one transverse strut 91, which may run substantially perpendicular to and between outer upper chord 53 and inner upper chord 54. Each transverse strut 91 may be connected at a transverse strut outer end 92 to an outer upper chord 53 and at a transverse strut inner end 93 at an inner upper chord 54. In various embodiments, each upper panel mount assembly 30 may further include at least one diagonal strut 101, which runs at a diagonal to and between outer upper chord 53 and inner upper chord 54. Each diagonal strut 101 may be connected at a diagonal strut outer end 102 to an outer upper chord 53 and at a diagonal strut inner end 103 at an inner upper chord 54. In various embodiments including both at least one transverse strut 91 and at least one diagonal strut 101, a transverse strut outer end 92 may connect to an outer upper chord 53 at substantially the same location as does a diagonal strut outer end 102 and a transverse strut inner end 93 may connect to an inner upper chord 54 at substantially the same location as does a diagonal strut inner end 103. In various embodiments, a single solar racking unit 15 may include five transverse struts 91 and four diagonal struts 101, arranged to form a favorable pattern for load distribution as shown in FIGS. 1-2, with diagonal struts 101 installed between transverse struts 91 and one set of two diagonal struts 101 having an opposed orientation to the other set of two diagonal struts 101.

In certain embodiments, inner upper chord 54 may be capable of bearing larger wind forces than outer upper chord 53 and lower chord 52, either by virtue of being thicker, being provided with a reinforced structure, by being formed of a more resilient material, or other suitable means. Without being bound to theory, inner upper chord 54 appears to bear greater loading from wind forces than do outer upper chord 53 and lower chord 52 in particular embodiments, and thus by increasing the load bearing capacity of inner upper chord 54 relative to the other two chords, smaller total expense can be made and optimum material efficiency achieved.

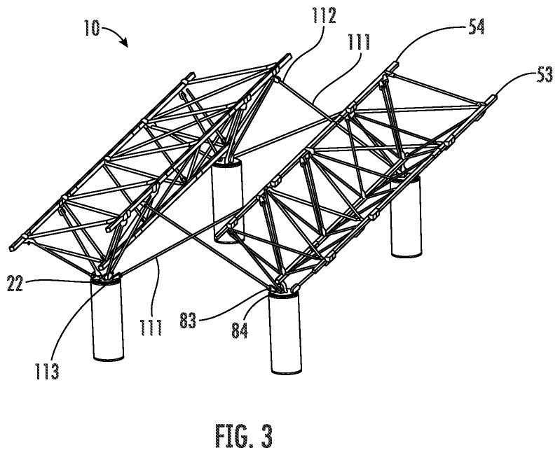

In various embodiments, each ground strut 41, web strut 61, transverse strut 91, diagonal strut 101, and cross-brace 111, may be connected to the various other components of a solar racking unit 15 by any suitable connecting means 80. Exemplary strut configurations and suitable connecting means 80 may include those configurations identified in U.S. Pat. No. 9,882,524, which is herein incorporated by reference in its entirety. Suitable connecting means are also shown by way of example in FIG. 1, where web struts 61 are stamped at their ends 62, 63 to provide a flat portion 81 that can be placed flush with a surface of a lower chord 52, outer upper chord 53, or inner upper chord 54 and secured via at least one bolt (not pictured) through at least one hole (not pictured) in the web strut end 62, 63 passing directly into a hole (not pictured) in one of the lower chord 52, outer upper chord 53, or inner upper chord 54 or passing into a bracket (not pictured) attached to a chord 52, 53, 54 and secured with a nut (not pictured). Such a means of attachment may allow for the use of less overall material in the strut, or the reduction of the number of needed parts for making the attachment. Ground struts 41 may include a hole (not pictured) at either unstamped end 42, 43 through which passes a pin 83, attaching the web strut end 42, 43 to a clevis 84. Clevis 84 may in turn be connected by a bolt and hole, pin and hole, or other suitable connector (not shown) to outer upper chord 53, inner upper chord 54, or base member upper end 22 either directly, or via a connected bracket 82. In FIGS. 2 and 3, cross-braces 111 are similarly shown connected by a pin 83 and clevis 84 connection to an inner upper chord 54 at cross-brace upper end 112 and a base member upper end 22 at a cross-brace lower end 113. In one embodiment (not shown), to increase the structural integrity of the attachment points of the ground struts with the base members, the base members are designed so that, after attaching the ground struts thereto, concrete (or other suitable material) may be poured over the attachment points of the ground struts to encase the attachment points in concrete.

As will be understood by one having ordinary skill in the art in light of this disclosure, each ground strut 41, web strut 61, transverse strut 91, diagonal strut 101, and cross-brace 111, may be connected to the various other components of a solar racking unit 15 by the described stamped end, bolt/hole/nut connection, the pin/clevis connector, welding, or other suitable attachment in a combination different from those combinations specifically shown or described herein. One having ordinary skill in the art will understand in light of this disclosure that an attachment that is “suitable” for certain connections in this context may mean that a particular connector must allow for and/or maintain an angled connection between components.

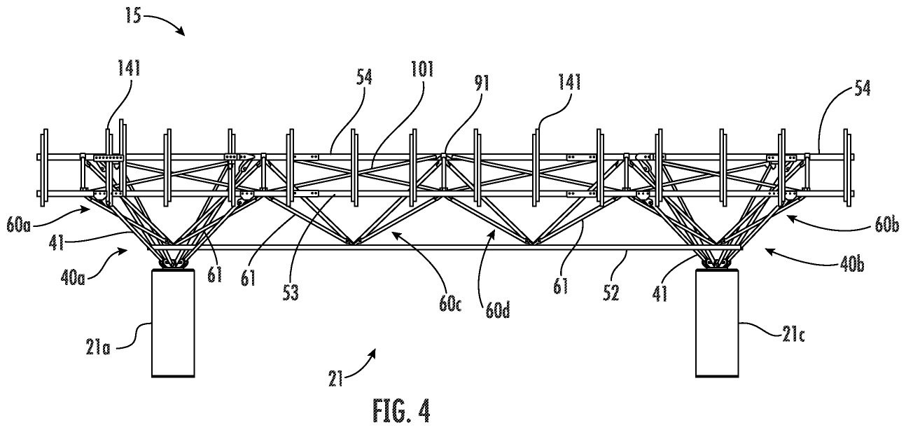

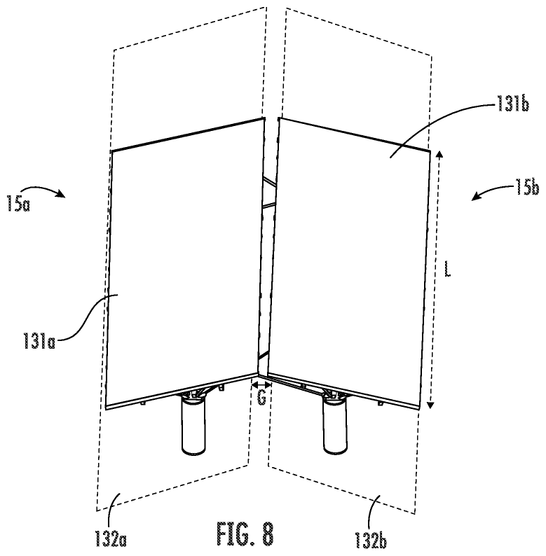

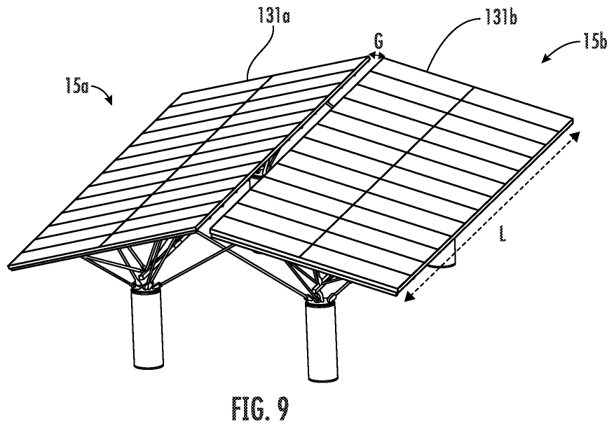

FIGS. 4-7 show solar panel racking units 15 wherein the units further include panel rails or purlins 141. As depicted, purlins 141 may be attached to outer upper chord 53 and inner upper chord 54 to provide a plane 132, 132a, 132b (shown by dashed lines in FIGS. 8-9 only) in which solar panels 131, 131a, 131b (shown in FIGS. 8-10 only) may rest. In alternative embodiments, purlins 141 may be attached to any of the outer upper chord 53, inner upper chord 54, diagonal struts 101, and transverse struts 91 or other feature of an underlying solar racking unit 15 so long as the purlins 141 so attached provide a secure attachment means for solar panels 131, 131a, 131b and allow attachment of solar panels 131, 131a, 131b substantially in plane 132, 132a, 132b.

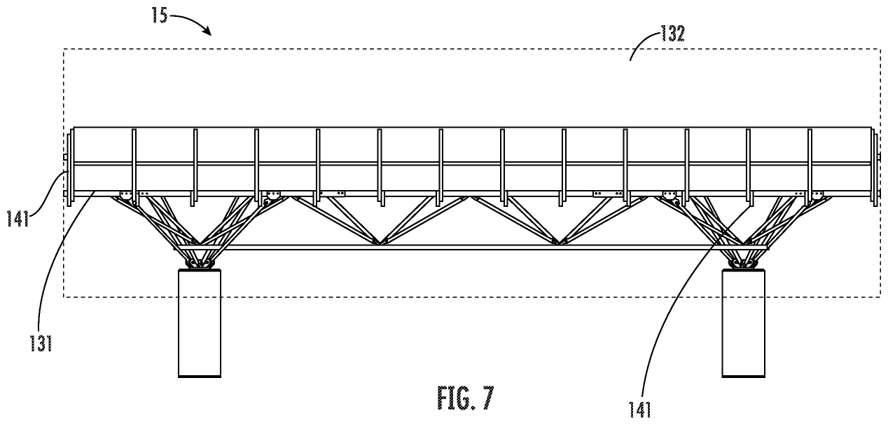

As shown in FIGS. 7-8, each solar racking unit supports solar panels 131. Solar panels 131, 131a, 131b may reside in solar panel plane 132, 132a, 132b and be attached or fitted to purlins 141. Solar panels 131, 131a, 131b may also be attached by any suitable means to upper panel mounting assembly 30 directly (not shown). In various embodiments, solar panels 131, 131a, 131b are substantially rectangular in their top-down profile.

Regarding FIG. 8, a first set of solar panels 131a of solar racking unit 15a is supported such that it forms tilt angle, θa (not shown), between solar panel plane 132a and an intersecting plane level with the horizon (not shown). A second set of solar panels 131b of solar racking unit 15b is supported such that it forms angle, θb (not shown), between solar panel plane 132b and an intersecting plane level with the horizon (not shown). The first and second sets of solar panels 131a, 131b may form a tent-like structure, with each of the first and second sets of solar panels sloping in an upward direction toward a midline formed between the two sets of solar panels 131a, 131b and preferably running the entirety of a length L of the solar racking units 15a, 15b. In various embodiments, θa and θb can be substantially equal in magnitude. In preferred embodiments, each of θa and θb is greater than about 0 and up to about 30 degrees. In further embodiments, each of θa and θb is between about 5 and about 30 degrees; in further preferred embodiments, between about 7 and about 28 degrees, in still further preferred embodiments, between about 10 and about 24 degrees, and in yet further preferred embodiments, between about 12 and about 18 degrees. The relative tilts of θa and θb may vary relative to one another as is particularly useful for solar capture, given the characteristics of a particular site (sunlight exposure, terrain, etc.). In further preferred embodiments, solar racking structure 10 may be oriented in situ such that the first set of solar panels slopes upward from a substantially eastward direction to a substantially westward direction and the second set of solar panels slopes upward from a substantially westward direction to a substantially eastward direction. FIG. 9 shows the solar panel racking structure of FIG. 8 from an alternative, top, side, perspective view.

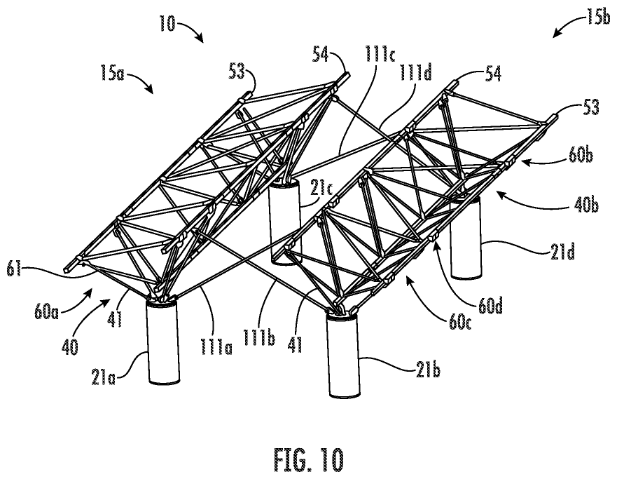

FIG. 10 shows two coupled solar racking units 15a, 15b forming a solar panel racking structure 10 having a tented structure. Solar racking units 15a, 15b are coupled via cross-braces 111. In the figure, a first cross-brace 111a spans from a first base member 21a of a first solar racking unit 15a to the inner upper chord 54 of a second solar racking unit 15b. A second cross-brace 111b spans from a first base member 21b of a second solar racking unit 15b to the inner upper chord 54 of the first solar racking unit 15a. A third cross-brace 111c spans from a second base member 21c of the first solar racking unit 15a to the inner upper chord 54 of the second solar racking unit 15b. A fourth cross-brace 111d spans from a second base member 21d of the second solar racking unit 15b to the inner upper chord 54 of the first solar racking unit 15a. First and second cross-braces 111a, 111b and third and fourth cross-braces 111c, 111d are offset relative to one another in terms of their attachment point along the length of their respective inner upper chord 54.

In the embodiment illustrated in FIG. 10, each solar racking unit 15a, 15b may include a first ground strut cluster 40a that connects the first base members 21a, 21b to their respective outer and inner upper chords 53, 54, and a second ground strut cluster 40b that connects the second base members 21c, 21d to their respective outer and inner upper chords 53,54. Each ground strut cluster 40 may include four ground struts 41. In each solar racking unit 15a, 15b, a first web strut cluster 60a may connect the lower chord 52 to its respective outer and inner upper chords 53, 54 at an end of the solar racking units 15a, 15b, a second web strut cluster 60b may connect the lower chord 52 to its respective outer and inner upper chords 53, 54 at an opposing end of the solar racking units 15a, 15b, a third web strut cluster 60c may connect the lower chord 52 to its respective outer and inner upper chords 53, 54 between the respective connections with outer and inner upper chords 53, 54 made by first and second web strut clusters 60a, 60b, and a fourth web strut cluster 60d may connect the lower chord 52 to its respective outer and inner upper chords 53, 54 between the respective connections with outer and inner upper chords 53, 54 made by second and third web strut clusters 60b, 60c. Each web strut cluster 60a, 60b, 60c, 60d may include four web struts 61.

In some embodiments, each solar racking unit of each solar racking structure may be coupled to the other via at least one cross-brace. In further embodiments, each solar racking unit of each solar racking structure may be coupled to the other via at least two cross-braces. In further embodiments, each solar racking unit of each solar racking structure may be coupled to the other via at least three cross-braces. In further embodiments, each solar racking unit of each solar racking structure may be coupled to the other via at least four cross-braces. In further embodiments, each solar racking unit of each solar racking structure may be coupled to the other via at least six cross-braces. In some embodiments, each cross-brace may attach the base assembly of one solar racking unit to the upper panel mount assembly of the other solar racking unit in the same solar panel racking structure. In further embodiments, each cross-brace may attach the base assembly of one solar racking unit to the inner upper chord of the other solar racking unit in the same solar panel racking structure.

In preferred embodiments and as shown in FIGS. 8-9, a gap G may be formed between the uppermost edge of a first set of solar panels 131a on a first solar racking unit 15a and the uppermost edge of a second set of solar panels 131b on a second solar racking unit 15b, following length L of the first and second solar racking units 15a, 15b. In preferred embodiments, gap G may be between about 8 and about 40 inches wide. In further preferred embodiments, gap G may be between about 15 and about 35 inches wide, in still further preferred embodiments, between about 18 and about 30 inches wide, in still further preferred embodiments, between about 21 and about 28 inches wide, and in still further preferred embodiments, between about 23 and about 25 inches wide.

Referring to FIG. 4, the solar racking unit 15, which may form part of a solar panel racking structure 10, may include base members 21 forming base assembly 20, lower rail 52, outer upper rail 53, inner upper rail 54, transverse struts 91, diagonal struts 101, and purlins 141. A first ground strut cluster 40a may connect the first base member 21a to outer and inner upper chords 53, 54, and a second ground strut cluster 40b may connect the second base member 21c to its respective outer and inner upper chords 53, 54. Each ground strut cluster 40 may include four ground struts 41. A first web strut cluster 60a may connect the lower chord 52 to its respective outer and inner upper chords 53, 54 at an end of the solar racking unit 15, a second web strut cluster 60b may connect the lower chord 52 to its respective outer and inner upper chords 53, 54 at an opposing end of the solar racking unit 15, a third web strut cluster 60c may connect the lower chord 52 to its respective outer and inner upper chords 53, 54 between the respective connections with outer and inner upper chords 53, 54 made by first and second web strut clusters 60a, 60b, and a fourth web strut cluster 60d may connect the lower chord 52 to its respective outer and inner upper chords 53, 54 between the respective connections with outer and inner upper chords 53, 54 made by second and third web strut clusters 60b, 60c. Each web strut cluster 60a, 60b, 60c, 60d may include four web struts 61.

Referring to FIG. 2, in exemplary embodiments, each solar racking unit 15 may have a length L and a width W forming an aspect ratio of width W:length L. The lengths L of each solar racking unit 15 in solar racking structure 10 are preferably substantially equivalent, and the widths W of each solar racking unit 15 in solar racking structure 10 are preferably substantially equivalent. In certain embodiments, the aspect ratio of each solar racking unit 15 in solar panel racking structure 10 may be less than 1 (the length L is greater than the width W). In further preferred embodiments, the aspect ratio may be less than 0.9, in further preferred embodiments, less than 0.8, in still further preferred embodiments, less than 0.7, and in still further preferred embodiments, less than 0.5. In preferred embodiments, each solar racking unit 15 in solar panel racking structure 10 may be oriented so that the length L of each solar racking unit 15 runs parallel to that of its complementary unit 15 when the solar racking units 15 are assembled and coupled to each other via cross-bracing 111 to form solar panel racking structure 10. In preferred embodiments, the width W and length L may be bound by the surface area of an upper face of a set of solar panels (not shown) on a given solar racking unit 15.

In preferred embodiments, L may be at least 40 feet, in further preferred embodiments, at least 60 feet, in still further preferred embodiments, at least 75 feet, and in yet further preferred embodiments, at least about 80 feet. In preferred embodiments, L may be at most 110 feet, in further preferred embodiments at most 100 feet, in still further preferred embodiments, at most 95 feet, and in still further preferred embodiments, at most about 90 feet.

In preferred embodiments, W may be at least 5 feet, in further preferred embodiments, at least 10 feet, in still further preferred embodiments, at least 12 feet, and in yet further preferred embodiments, at least about 13 feet. In preferred embodiments, W may be at most 27 feet, in further preferred embodiments at most 23 feet, in still further preferred embodiments, at most 21 feet, and in still further preferred embodiments, at most about 15 feet.

Referring to FIG. 1, each solar racking unit 15 has interior dimension B (shown with dashed line labeled “B”), spanning between the centers of base members 21 and cantilever length C (shown with dashed line labeled “C”), spanning from the centers of base members 21 to a nearest outer point of the length dimension L.

In preferred embodiments, the interior dimension B may be at least 30 feet, in further preferred embodiments, at least 35 feet, in still further preferred embodiments, at least 40 feet, in still further preferred embodiments, at least 50 feet, and in still further preferred embodiments, at least 70 feet. In preferred embodiments, the interior dimension B may be at most 90 feet, in further preferred embodiments, at most 85 feet, in still further preferred embodiments, at most 80 feet, and in still further preferred embodiments, at most 75 feet.

In preferred embodiments, the cantilever length C may be at least 7 feet, in further preferred embodiments, at least 10 feet, in further preferred embodiments, at least 13 feet, in still further preferred embodiments, at least 16 feet, and in yet further preferred embodiments, at least 19 feet. In preferred embodiments, the cantilever length C may be at most 30 feet, in further preferred embodiments, at most 25 feet, in still further preferred embodiments, at most 22 feet, and in still further preferred embodiments, at most 20 feet.

In various embodiments, the solar panel racking structures disclosed herein can preferably withstand forces in excess of those associated with category 5 hurricane force winds as measured according to ASCE 49-21 (“Wind Tunnel Testing for Buildings and Other Structures”) and calculated according to ASCE 7-16 (“Minimum Design Loads and Associated Criteria for Buildings and Other Structures”) through a range of panel tilt angles. In certain embodiments, load distribution by the solar panel racking structures disclosed herein may be such that the solar panel racking structures experience a maximum uplift net gust normal force coefficient (“GCn”) magnitude of 4.0 when category 5 hurricane force winds are applied to the structure and as measured according to ASCE 49-21 and calculated according to ASCE 7-16. In further embodiments, load distribution by the solar panel racking structures disclosed herein may be such that the solar panel racking structures experience a maximum uplift GCn magnitude of 3.0 when category 5 hurricane force winds are applied to the structure and as measured according to ASCE 49-21 and calculated according to ASCE 7-16; in further embodiments, 2.5; in further embodiments, 2.25; in further embodiments, 2.0; in further embodiments, 1.5; and in still further embodiments, 1.0.

In various embodiments, the upper panel mount assembly 30 with attached cross-braces 111 or a portion thereof can preferably withstand the forces applied by crane lifting, in addition to, when the panel mount assembly 30 with cross-braces 111 or a portion thereof is incorporated into the solar racking units 15 of a solar panel racking structure 10, forces applied by strong winds, including winds consistent with category 5 hurricanes.

In various embodiments, the solar panel racking structures disclosed herein may be used in ground-mount solar panel racking applications. In such embodiments, the base assembly is preferably appropriately sized to achieve proper height.

In various embodiments, the solar panel racking structures disclosed herein may be used in canopy solar panel racking applications. In such embodiments, the base assembly may be appropriately sized to achieve proper height.

In various embodiments, the solar panel racking structures disclosed herein may be used in roof-mount solar panel racking applications. In such embodiments, the base assembly is preferably appropriately sized to achieve proper height off of a supporting roof, and base members of the base assembly are preferably properly selected for attachment to the roof.

A method of assembling a prefabricated assembly is also disclosed. The method may include the steps of: 1) assembling the upper panel mount assembly 30 or a portion thereof according to any of the embodiments of the upper panel mount assembly 30 described herein at a remote site or on the ground at a work site; 2) providing a base assembly 20 at a work site; 3) crane lifting or otherwise lifting the upper panel mount assembly 30 or a portion thereof into place on the base assembly 20 and attaching the ground struts of the upper panel mount assembly 30 and cross-braces 111 to the base assembly to support the upper panel mount assembly 30 or portion thereof; and optionally 4) attaching any remaining portions of the upper panel mount assembly 30 to the upper panel mount assembly 30 or portion of the upper panel mount assembly 30. Cross-braces 111 may be attached to upper panel mount assembly 30 before or during any of the above steps.

In another embodiment, the method of assembling a solar panel racking structure may include the steps of A) providing a first and second upper panel mount assembly and a first and second base assembly; B) securing the first and second base assembly at a work site; C) lifting the first upper panel mount assembly into place on the secured first base assembly; D) lifting the second upper panel mount assembly into place on the secured second base assembly; E) providing first and second cross-braces; F) attaching a first end of the first cross-brace to the first upper panel mount assembly and a second end of the first cross-brace to the second base assembly; G) attaching a first end of the second cross-brace to the second upper panel mount assembly and a second end of the second cross-brace to the first base assembly; H) securing a first set of solar panels to the first upper panel mount assembly; and I) securing a second set of solar panels to the second upper panel mount assembly, such that the first and second sets of solar panels each slope upward toward a midpoint line between the first and second upper panel mount assemblies to form a tent-like structure.

The solar panel racking structure assembled according to the method set forth herein may include any of the features or components referred to herein. For example, each base assembly may include a first base member and a second base member. Further, one or both of the upper panel mount assemblies may include an outer upper chord and an inner upper chord, a lower chord, a first and second web strut clusters, a first and second ground strut clusters, and a first and second transverse struts, wherein each of the first and second transverse struts of an upper panel mount assembly may connect the outer upper chord to the inner upper chord of such upper panel mount assembly. Further, the method may include the step of attaching the ground struts of an upper panel mount assembly to the respective base assembly to support the upper panel mount assembly.

The disclosure will now be illustrated with reference to the following non-limiting examples.

### EXAMPLES

### Wind Tunnel Testing Example 1

Three small-scale model solar panel racking structures are assembled and subjected to wind tunnel testing in an atmospheric boundary layer wind tunnel according to ASCE 49-21. The small-scale models have the configuration identified in FIG. 10 with model solar panels resting on each solar panel racking unit. Each model solar panel racking structure is assembled such that when scaled up by a factor of 72, it has roughly the dimensions identified in TABLE 1, below. Actual model measurements are 1/72 of the measurements provided in TABLE 1. Base members are columnar and cylindrical in shape. All model components are constructed by stereolithography (“SLA”) resin 3D printing. Each solar panel racking structure is tested separately according to the same procedure. The solar panel racking structure of Structure A each has tilt angles, θa and θb, of 7 degrees. The solar panel racking structure of Structure B has tilt angles, θa and θb, of 15 degrees. The solar panel racking structure of Structure C has tilt angles, θa and θb, of 25 degrees. Each of Structures A, B, and C is tested with simulated category 5 hurricane force (or greater) winds approaching from different angles. Each structure is tested at a variety of wind approach azimuths, beginning at a zero-degree wind approach and rotating through 10 degree increments to a 180-degree wind approach.

TABLE 1
Solar Panel Racking Structure Dimensions

| Dimension | Value |
|---|---|
| Length, L | 536 in. |
| Width, W | 173 in. |
| Gap, G | 24 in. |
| Tilt Angles, | 7 (Structure Set A), 15 (Structure Set B), |
| θa and θb | 25 (Structure Set C) degrees |
| Cantilever Length, C | 88 in. |
| Interior Dimension, B | 360 in. |
| Aspect Ratio (W:L) | 0.32 |
| Base Member Height | 57 in. |

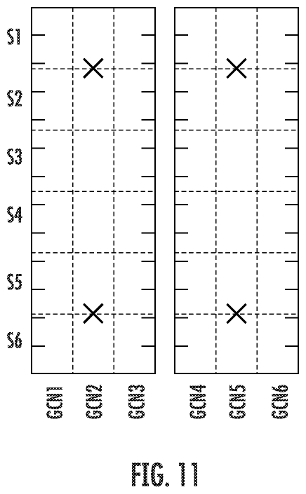

The uplift GCn is calculated for various locations on the model solar panel racking structures for each wind approach azimuth based on pressure readings taken using standard pressure transducers located at designated points along each solar panel racking structure. FIG. 11 shows a schematic, top-down view of an individual solar panel racking structure. For each model solar panel racking structure tested, pressure transducers are located on the solar panel racking structures in each of the labeled rectangles identified in FIG. 11, with an individual rectangle corresponding to the intersection of a row GCN1 to GCN6 and a column 1 to 6. “X” marks indicate the location of base members. GCn is calculated from pressure readings using the calculation methods specified in ASCE 7-16.

The expected maximum uplift GCn for each of Structures A, B, and C is shown in TABLE 2 with its respective location (specified by a row, GCN1 to GCN6, and column, 1 to 6, designation). Maximum uplift GCn is simply the largest GCn value (by absolute value) for a given structure.

TABLE 2

| | | |
|---|---|---|
| | | Structure |
| Measure | Value | Location |

Structure Set A (7 degree tilt)

| | | |
|---|---|---|
| Maximum Uplift GCn | 0.82 | GCN3, 2 |

Structure Set B (15 degree tilt)

| | | |
|---|---|---|
| Maximum Uplift GCn | 1.64 | GCN3, 2 |

Structure Set C (25 degree tilt)

| | | |
|---|---|---|
| Maximum Uplift GCn | 2.02 | GCN3, 2 |

Each structure withstands Category 5 hurricane-strength wind forces.

The particular solar panel racking systems as herein disclosed, illustrated, and described are to be understood as only embodiments of the present invention and thus representative of the subject matter which is broadly contemplated by the present invention. The scope of the present invention fully encompasses other embodiments that may be or may become obvious to those skilled in the art, and the scope of the present invention is accordingly to be limited by nothing other than the appended claims. In the appended claims, reference to an element in the singular is not intended to mean “one and only one” unless explicitly so stated, but rather “one or more”. All structural and functional equivalents to the elements of the above-described embodiment that are known or later come to be known to those of ordinary skill in the art are expressly incorporated herein by reference and are intended to be encompassed by the present claims. Moreover, it is not necessary for a device to address each and every problem sought to be solved by the present invention for it to be encompassed by the present claims. Furthermore, no element, component, or combination in the present disclosure is intended to be dedicated to the public regardless of whether the element, component, or method step is explicitly recited in the claims. No claim element herein is to be construed under the provisions of 35 U.S.C. § 112, sixth paragraph, unless the element is expressly recited using the phrase “means for.” Absent express definitions herein, all claim terms are to be given all ordinary and accustomed meanings that are not irreconcilable with the present specification and the file history.

Further, the purpose of the Abstract is to enable the various patent offices and the public generally, and especially the scientists, engineers, and practitioners in the art who are not familiar with patent or legal terms or phraseology, to determine quickly from a cursory inspection the nature and essence of the technical disclosure of the application. The Abstract is not intended to be limiting as to the scope of the invention in any way.

What is claimed is:

1. A solar panel racking structure comprising:
a first and second solar racking unit, each having a base assembly and an upper panel mount assembly;
a first and second set of solar panels, wherein the first set of solar panels are secured to the upper panel mount assembly of the first solar racking unit and the second set of solar panels are secured to the upper panel mount assembly of the second solar racking unit; and
at least first and second cross-braces, wherein the first cross-brace attaches the base assembly of the first solar racking unit to the upper panel mount assembly of the second solar racking unit and the second cross-brace attaches the base assembly of the second solar racking unit to the upper panel mount assembly of the first solar racking unit;
wherein the first and second set of solar panels each slope upward toward a midpoint line between the first solar racking unit and the second solar racking unit such that the solar panel racking structure forms a tent-like structure.

2. The solar panel racking structure of claim 1, wherein the structure is a ground-mount solar panel racking structure, and a lowest edge of the solar panels secured thereon resides 1.5 feet to 8 feet above the ground.

3. The solar panel racking structure of claim 1, wherein each of the magnitude of a tilt angle, θa, formed between a plane formed by the first set of solar panels and a plane formed by the horizon and the magnitude of a tilt angle, θb, formed between a plane formed by the second set of solar panels and the plane formed by the horizon, is between 5 and 30 degrees.

4. The solar panel racking structure of claim 1, further comprising a gap between an uppermost edge of the first set of solar panels and an uppermost edge of the second set of solar panels.

5. The solar panel racking structure of claim 4, wherein the gap is between 8 and 40 inches wide.

6. The solar panel racking structure of claim 1, wherein the upper panel mount assemblies of each solar racking unit are capable of withstanding the forces applied by crane lifting of the upper panel mount assemblies, and wherein the solar panel racking structure is capable of withstanding category 5 hurricane force winds.

7. The solar panel racking structure of claim 1, wherein the solar panel racking structure provides a load distribution in category 5 hurricane force winds such that the solar panel racking structure does not experience a GCn greater than 3.0 as measured according to ASCE 49-21 and calculated according to ASCE 7-16.

8. The solar panel racking structure of claim 1, wherein each of the cross-braces is rigid.

9. The solar panel racking structure of claim 1, wherein each base assembly is composed of concrete and each of the cross-braces is composed of steel.

10. The solar panel racking structure of claim 1, wherein each solar racking unit defines a width dimension, W, and a length dimension, L, with each dimension bounded by the surface area of an upper face of each set of solar panels, thus defining an aspect ratio for each solar racking unit, W:L.

11. The solar panel racking structure of claim 10, wherein the aspect ratio of each solar racking unit is less than 0.7.

12. The solar panel racking structure of claim 10, wherein W for each solar racking unit is between about 10 feet and about 27 feet and L for each solar racking unit is between about 44 feet and about 110 feet.

13. The solar panel racking structure of claim 1, wherein each solar racking unit defines an interior dimension, B, spanning between the centers of the base assemblies, and wherein B is between 30 feet and 90 feet in length.

14. The solar panel racking structure of claim 10, wherein each solar racking unit defines a cantilever dimension, C, spanning from the center of each base assembly to a nearest outer end of the length dimension L, and wherein C is between 10 feet and 30 feet in length.

15. The solar panel racking structure of claim 10, wherein a gap is formed between an uppermost edge of the first set of solar panels and an uppermost edge of the second set of solar panels along the entirety of the length dimension, L of the solar racking units and wherein the gap is between about 8 and about 40 inches wide.

16. The solar panel racking structure of claim 1, wherein the first and second solar racking units each further comprise an upper panel mount assembly having an outer upper chord, an inner upper chord, and first and second transverse struts, wherein each of the first and second transverse struts of an upper panel mount assembly connects the outer upper chord to the inner upper chord of said upper panel mount assembly.

17. A solar panel racking structure comprising:
a first solar racking unit comprising:
a base assembly comprising at least first and second base members;
an upper panel mount assembly comprising:
an outer upper chord and an inner upper chord;
a lower chord;
at least first and second web strut clusters;
at least first and second ground strut clusters; and
at least first and second transverse struts, wherein each of the first and second transverse struts of the first solar racking unit connects the outer upper chord of the first solar racking unit to the inner upper chord of the first solar racking unit,
a second solar racking unit comprising:
a base assembly comprising at least first and second base members;
an upper panel mount assembly comprising:
an outer upper chord and an inner upper chord;
a lower chord;
at least first and second web strut clusters;
at least first and second ground strut clusters; and
at least first and second transverse struts, wherein each of the first and second transverse struts of the second solar racking unit connects the outer upper chord of the second solar racking unit to the inner upper chord of the second solar racking unit, and
at least first and second cross-braces;
wherein the first cross-brace attaches the first base member of the first solar racking unit to the inner upper chord of the second solar racking unit and the second cross-brace attaches the first base member of the second solar racking unit to the inner upper chord of the first solar racking unit;
wherein each web strut cluster of each solar racking unit attaches the lower chord to the inner and outer upper chords of each, respective solar racking unit; and
wherein the first ground strut cluster of each solar racking unit attaches the first base member to the inner and outer upper chords of each, respective solar racking unit and the second ground strut cluster of each solar racking unit attaches the second base member to the inner and outer upper chords of each, respective solar racking unit.

18. The solar panel racking structure of claim 17, wherein the first solar racking unit supports a first set of solar panels attached directly or indirectly to the upper panel mount assembly of the first solar racking unit and the second solar racking unit supports a second set of solar panels attached directly or indirectly to the upper panel mount assembly of the second solar racking unit.

19. The solar panel racking structure of claim 18, wherein each solar racking unit further comprises third and fourth web strut clusters.

20. The solar panel racking structure of claim 18, wherein the first set of solar panels and second set of solar panels are supported by their respective solar racking units such that each set of solar panels slopes upward toward a midpoint line between the solar racking units, and the solar panel racking structure forms a tent-like structure.

21. The solar panel racking structure of claim 17, wherein each of the web struts, ground struts, transverse struts, and cross-braces is rigid.

22. The solar panel racking structure of claim 17, wherein each base member is composed of concrete.

23. A method for assembling a solar panel racking structure comprising the steps of:
A) providing a first and second upper panel mount assembly and a first and second base assembly;
B) securing the first and second base assembly at a site;
C) lifting the first upper panel mount assembly into place on the secured first base assembly;
D) lifting the second upper panel mount assembly into place on the secured second base assembly;
E) providing first and second cross-braces;
F) attaching a first end of the first cross-brace to the first upper panel mount assembly and a second end of the first cross-brace to the second base assembly;
G) attaching a first end of the second cross-brace to the second upper panel mount assembly and a second end of the second cross-brace to the first base assembly;
H) securing a first set of solar panels to the first upper panel mount assembly; and
I) securing a second set of solar panels to the second upper panel mount assembly, such that the first and second sets of solar panels each slope upward toward a midpoint line between the first and second upper panel mount assemblies to form a tent-like structure.

24. The method of claim 23, wherein the each base assembly includes a first base member and a second base member.

25. The method of claim 24, wherein the first upper panel mount assembly comprises an outer upper chord and an inner upper chord, a lower chord, a first and second web strut cluster, a first and second ground strut cluster, and a first and second transverse strut, wherein each of the first and second transverse struts connects the outer upper chord to the inner upper chord.

26. The method of claim 25, further comprising the step of J) attaching the ground struts of the first upper panel mount assembly to the base assembly to support the first upper panel mount assembly.
